(19) United States
(12) Patent Application Publication
(10) Pub. No.: US 2011/0246245 A1
(43) Pub. Date: Oct. 6, 2011

(54) Return of Excess Contribution System ("RECS") dividend distribution software application

(76) Inventor: Ruth Ann Coleman, Woodstock, GA (US)

(21) Appl. No.: 13/079,860

(22) Filed: Apr. 5, 2011

Related U.S. Application Data
(60) Provisional application No. 61/321,053, filed on Apr. 5, 2010.

(51) Int. Cl. G06Q 40/00

(52) U.S. Cl. 705/4

(57) ABSTRACT

In accordance with the present invention, there is a standalone application that provides a low cost dividends modeling and administration tool for entities who pool premiums and return a portion of the excess back to the members in the form of dividends or premium credits. This application is designed to meet the clients' dividends distribution needs at a low cost with minimal ramp-up efforts, regardless of the insurance administration system they already have in place.

### RELATED APPLICATIONS

The present application is a continuation-in-part application of U.S. provisional patent application Ser. No. 61/321,053—EFS ID: 7355130, filed Apr. 5, 2010, for PROVISIONAL PATENT, by Ruth Ann Coleman, included by reference herein and for which benefit of the priority date is hereby claimed.

### FIELD OF THE INVENTION

The present invention relates to distributions paid out within the insurance industry and, more specifically, to insurance entities who have pooled premium contributions from associated members of the pool and wish to return a portion of the excess contributions back to those members.

### BACKGROUND OF THE INVENTION

A growing alternative to the traditional (and more costly) form of insurance are SELF INSURED entities that pool the premiums and risks of their members. This approach fosters a natural incentive to manage their losses. As a result, a portion of the excess is often returned to the more profitable members in the form of DIVIDENDS or Premium Credits encouraging the retention of those desirable members.

The problem has been that while there are many insurance administration systems available, most do not offer a dividends module or solution. Therefore, a big factor in the decision to launch a dividends distribution program is the cost of development and implementation. Consequently, the decision has to be made whether to develop the vehicle in-house or utilize outside resources both of which are costly and daunting, often delaying the decision all together.

There are vendors such as Third Party Administrators (TPA) or actuarial firms that offer services to administer dividend distributions usually for an hourly or flat rate.

If the company has resources, they can write an application either in-house or pay an outside vendor to write the application for them.

The biggest downside of either of these solutions is cost both in terms of cash outlay and developmental time. Secondary to that would be the flexibility of the deliverables. If the company wants to change what they want to see, say add a report or if they want to play what-if and see comparisons of multiple dividend scenarios, the development is often cost prohibitive.

Also, if the company replaces their main insurance administration system, any existing process in place whether from an outside service or from an existing in-house program will need to be changed to accommodate the new system. This dividend distribution system, on the other hand will not need to be changed, only the source of the data that feeds it.

### SUMMARY OF THE INVENTION

In accordance with the present invention, there is a standalone application that provides a low cost dividends modeling and administration tool for entities who pool premiums and return a portion of the excess back to the members in the form of dividends or premium credits. This application is designed to meet the clients' dividends distribution needs at a low cost with minimal ramp-up efforts, regardless of the insurance administration system they already have in place. The application will generate dividends distributions and associated agent rewards as defined to the system using data from the entities' main insurance administration system.

It is most advantageous to provide an application that functions stand-alone because regardless of the entities' existing insurance administration system or changes that may take place in the existing insurance administration system, this application will need no changes, only the data that feeds it.

It will be further advantageous to provide this application in two models for flexibility.

1. Software as a Service (“SaaS”) model where no software installation is needed, rather a subscription is purchased giving online access to the application.

2. Software license where the application is installed onto the clients' server or PC.

It will further be advantageous to provide a modeling tool set where managers can define and compare the ultimate results of multiple scenarios side-by-side before making the decision on which to choose.

It will also be advantageous to provide easy automated communication to the policy holders and agents via email.

It is also my intention to provide online access to the clients' agents and policy holders in addition to the managers and administrators.

It is my intention to enforce data integrity by performing a data auditing process as well as providing a worksheet for the purpose of balancing premium and losses back to the clients' main insurance administration system and to balance the distributed dividends back to declared dividend amount(s)

It will further be advantageous to provide access to historical dividends for year to year comparison with the ability to quickly email current and historical reports.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an overview of a standalone dividend distribution system view of the integration between a clients' existing system and this software application referred to as “recs”. recs uses data from the clients' existing system via a data link or via data import from the existing system into recs;

FIG. 2 is a data interchange view of a between the clients' existing insurance administration system(s) and this software application referred to as “recs”;

FIG. 3 is a table data elements view of a data that said software application uses as input to calculate and generate dividends as well as the tables containing the resulting dividend distributions;

FIG. 4 is a modeling tool view of a modeling portion of said software application functionality;

FIG. 5 is a dividend administration tool view of an elements contained in said software application for the purpose of processing a dividend; and

FIG. 6 is an online access view of a how this software application referred to as “recs” makes the dividend information available to managers, agents and policy holders as defined in the security section (shown in FIG. 4).

For purposes of clarity and brevity, like elements and components will bear the same designations and numbering throughout the Figures.

### DESCRIPTION OF THE PREFERRED EMBODIMENT

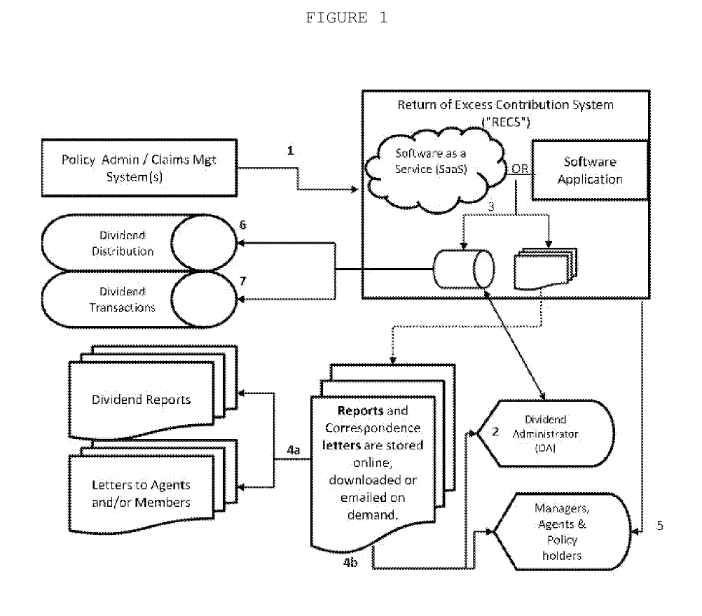

FIG. 1 is a birds eye view of the integration between a clients' existing insurance administration system 24 and software application referred to as “RECS”. The following describes each general activity. These are described in more detail in subsequent drawings.

1—Data is exported from existing insurance administration system 24 and imported into RECS

2—Dividend Administrator sets up all necessary parameters defining the distributions.

3—Using RECS, the Dividend Administrator generates reports, letters, dividend and agent reward data and transactions

4a—Reports and Letters are downloaded to clients' server as controlled by the Dividend Administrator.

4b—Reports and Letters are emailed to the appropriate person as controlled by the Dividend Administrator.

5—Managers, Agents and Policy Holders can access dividend information as defined in the security by the Dividend Administrator.

6—Detail and Summary distribution data is downloaded to Client's server

7—Dividend transactions (check data) is downloaded to Client's server and into Check writing system or into existing policy administration system as credits.

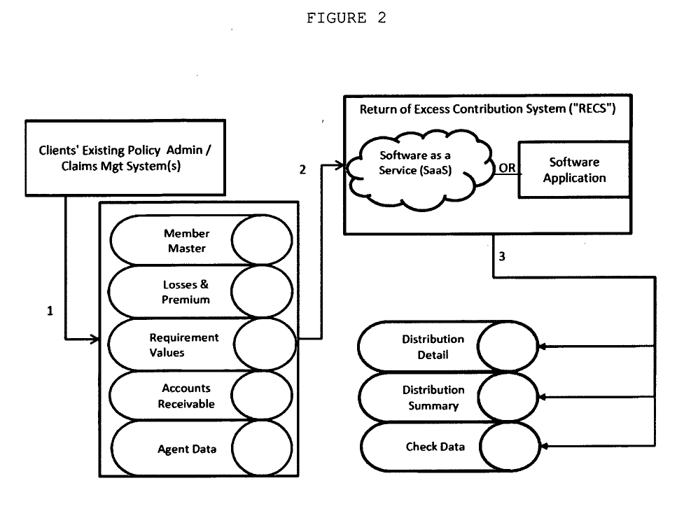

FIG. 2 is a drawing that shows data flow between RECS and the clients' existing insurance administration system 24(s).

Following are those steps described in more detail.

1. Data is extracted from the clients' existing system(s) into these predefined tables or views.

a. Member Master which holds the member's demographic and setting information

b. Losses & Premium which hold the Premium and losses for all years to be considered in the distribution

c. Requirement Values which holds the members' values that are associated with the user defined requirements within RECS

d. Accounts Receivable which contains any outstanding premium or dues owed to the insurer.

e. Agents Data which contains the demographic and setting information for any agents the insurer may use

The specific data elements for the above tables or view are listed in drawing #3 labeled “Table Data Elements”

2. The data extracted in step 1 is then either imported into RECS or linked to RECS for dividend processing.

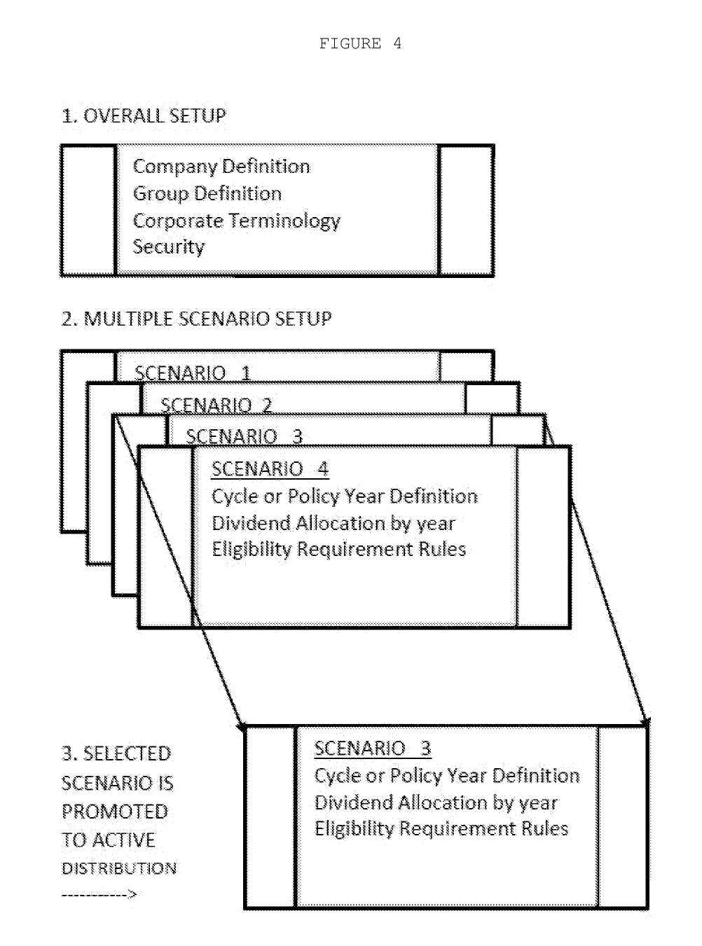

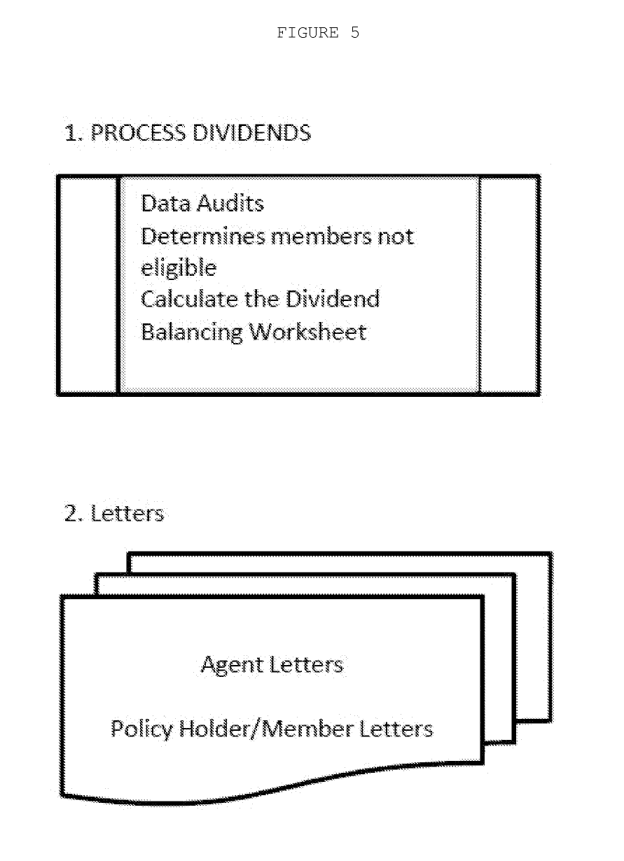

The process of defining and calculating the dividend distributions are described in detail in FIG. 4 labeled “Scenario Definitions” and FIG. 5 labeled “Dividend Distribution Processing”

3. Once the distribution(s) are defined and calculated, the following 3 tables of data can be exported from RECS.

a. Distribution Detail which contains a record every year considered by individual member giving the disposition of that year for the member (whether he/she received a dividend. If not, why and if he/she did, how much) This table included members whether they received a dividends or not.

b. Distribution Summary which contains a record for all members considered for a distribution along with the total dividend amount. This table included members whether they received a dividends or not.

c. Check Data which contains a check record for all members that did received a dividend.

The client can use the data in these tables any way they want. They may want to import the Check Data into their check writing system or they may want to import it into their Policy Admin system as a premium credit.

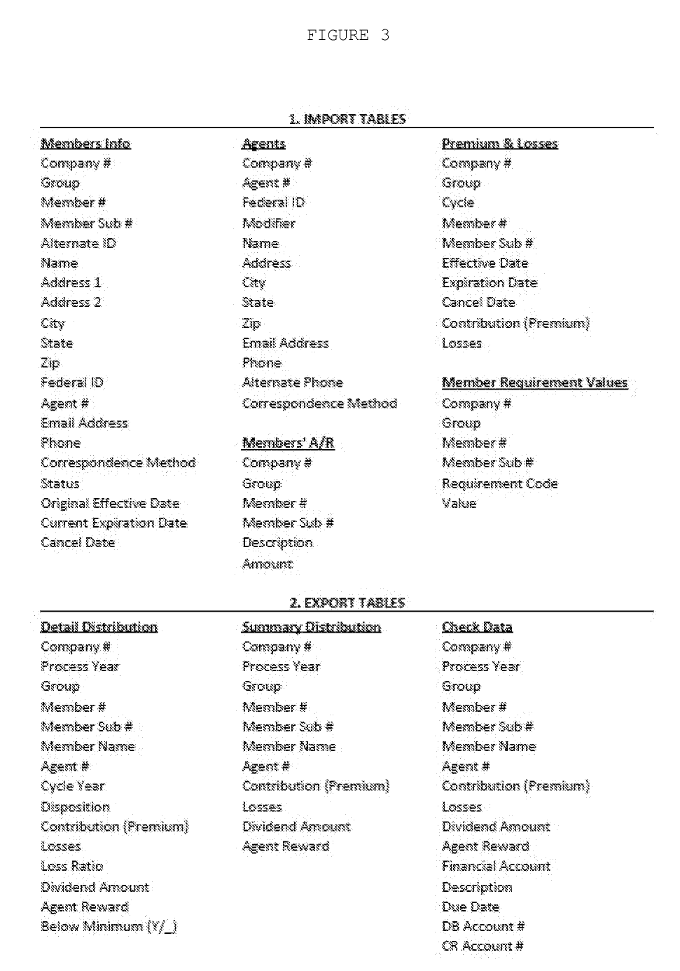

FIG. 3 shows the data that is used by RECS that comes from the existing insurance administration system 24. The data can either be imported into the RECS application or the data can reside outside and RECS can be linked to the data.

1. IMPORT TABLES

There are 5 import/linked tables described below. Figure 3 provides the individual data elements.

a. Members+ Info table contains the individual members' demographic information as well as other identifying fields

b. Agents table contains the individual agents' demographic information as well as other identifying fields

c. Members' A/R table contains records of any money the member owes the insurer. The inclusion of this data is optional.

d. Premium and Losses table contains the premium and losses for a given period of time (usually a year)
e. Member Requirement Values table contain the values associated with the requirement codes as defined by the user inside RECS.

2. EXPORT TABLES

There are 3 available export tables that provide all the information generated by RECS for the use at the discretion of the user.

a. Detail Distribution table contains the resulting dividends allocated to the members for each cycle (or year) considered for a dividend distribution. The cycles are defined by the user during setup.

b. Summary Distribution table contains the summary information of the Detail Distribution table.

FIG. 4 shows the three categories of the Modeling functionality contained in RECS.

1. OVERALL SETUP—The user defines these to RECS which applies to all Scenarios (described next)

a. Company information including demographic, company logo and signature to be used in the letter generation.

b. Group definition which holds information sub grouping the company. The number of groups that can be defined is unlimited except that at least one must be defined.

c. Corporate Terminology is optional and allows the client to change the default labeling of pertinent data elements. For example within the company, they may typically refer to a policyholder as a member or an insured. Names of reports can also be re-titled.

d. Security information is stored to define which users have access to what information.

2. MULTIPLE SCENARIO SETUP—The user may define up to 10 scenarios describing different distribution definitions which include:

a. Cycle (Policy Year) definition elements

1. Group(s) to include

2. Policy Year(s) to include when calculating excess.

3. Loss Ratio limit used in member eligibility determination.

4. Allocation Basis (Pro-rata or Percent of Premium) This impacts the calculation of the dividend where the pro-rata basis calculates the dividend based on the members' CONTRIBUTION TO EXCESS and returns that excess on a pro-rata bases while the Percent of Premium basis simply distributes the declared dividend back to the members (still on a pro-rata basis) but based on their CONTRIBUTION TO PREMIUM—regardless of their losses and actual contribution to the excess. The client may have a combination of both allocation basis for a given experience year.

5. Loss Fund—defines the portion (percentage) of the premium to be used when calculating the excess.

6. Percent of Premium to be used only when “Percent of Premium” is chosen as the Allocation Basis.

7. Return amount allocated to a particular Policy Year.

8. Free-form comment field used for general notes.

b. Eligibility Requirement Rules—are unlimited in number of rules and completely user defined. These are used to set the requirements for eligibility of receiving a dividend. A member must meet all rules to be eligible.

Sample Eligibility Requirement Rules are:

1. Member Activity code must be ‘A’ (Active).

2. Accounts Receivable amount must be less than or equal to zero.

3. Member type must not be equal to ‘HOUSE ACCOUNT’.

4. Date member became a member must be on or before Jan. 1, 2006.

3. SELECTED SCENARIO IS PROMOTED TO ACTIVE DISTRIBUTION.

Each scenario is processed in the Dividend Administration Tool (described in FIG. 5) and the results are compared side-by-side. Finally a scenario is selected and promoted to active distribution.

FIG. 5 shows the elements in RECS used to process a dividend.

1. PROCESS DIVIDENDS—The actual calculation and distribution contains these processes:

a. RECS runs the imported data as well as the setup data through the following 17 data audits to ensure that there are no data anomalies that would prevent the dividends process

Table Check

Cycle Data Invalid Group

Cycle Data No Loss Ratio

Cycle Data No Return amount declared

Member Cycle Data No Contribution amount

Member Cycle Data Invalid Expiration date

Member Cycle Data Invalid Group

Member Cycle Data Invalid Member Number

Member Master Invalid Correspondence method

Member Master Email Correspondence method selected but no email address

Member Master Invalid Agent Number

Member Master Cancel date Less than Effective date

Member Master Invalid Group

Member Master Invalid Member Status

Member Requirements Invalid Group

Member Requirements Invalid Requirements Code

Scenario Scenario record with no Scenario Code

Scenario No Email address

b. Determines and Lists members not eligible and why.

c. Calculate the distribution to all eligible members

d. Balancing worksheet that shows Premium, Losses and Dividends by Group and Policy Year. The screen also provides fields for the user to enter the equivalent based on a summary report generated in their source (main) insurance administration system(s). Once those figures are entered, RECS compares them and provides a balancing report. The idea is that the user should balance back to their main system.

2. LETTERS—RECS contains the ability to generate user defined ‘form’ letters to the Agents and or the Policy holder. The functionality is described in detail below. All components (except the recipients' name and address) are optional.

a. The components in the Agent Letters are

1. Company Logo

2. Letter Date

3. Recipients name and address

4. Body of the Letter

5. Signature (if added to the Company definition)

6. List of the Agents' Eligible Policy holders.

(Numbers 7, 8, and 9 only apply if the user chose to include Number 6)

7. Policy Holder Name

8. Dividend amount

9. Amount Policy Holder owes to the insurer (before dividend)

b. The components in the Policy Holder Letters are

1. Company Logo

2. Letter Date

3. Recipients name and address

4. Body of the Letter (part 1)

5. Dividend Amount

6. Amount Policy Holder owes to the insurer (before dividend)

7. Agent Contact information

8. Body of the Letter (part 2)

9. Signature (if added to the Company definition)

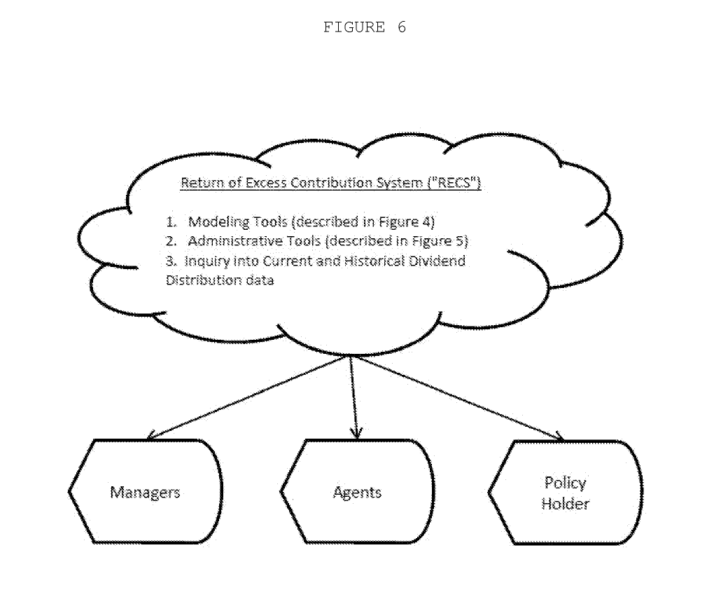

FIG. 6 demonstrates the function of RECS that allows the users to access the data as defined in security.

An example of how this may be set up is as follows:
A Manager can have access to all tools and inquiry.
Agents are set up to view current and historical information and add notes to his/her Policy Holders only.
Policy Holders are only able to view his/her own dividend information both current and historical.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims:

1. A return of excess contribution system (“recs”) dividend distribution software application for the purpose of faciliting the administration and distribution of excess insurance premium contributions to a group of members, individuals or entities who pool the premiums of their members, comprising:
means for a software application, residing either online or on the client's server or pc;
means for insurance entity who pools the premiums of its members and intends to return a portion of the excess contribution back to those members;
means for holds premium, loss, accounts receivable, policy holder and agent data for said insurance entity;
means for access to data from said insurance entitie's said existing insurance administration system(s). this data access is either linked to or imported into said software application;
means for using said software application, describing their company to the application including name, address, logo and signature file and to assign terminology used in reports and screens to match their corporate culture. then the means to model multiple dividend distribution ‘scenarios’, generate the potential outcome of each scenario allowing company to compare them side by side for the purpose of choosing the one that best meets their dividend distribution needs;
means for administering the chosen dividend scenario, specifically to generate distribution reports, generate user defined form letters for agents and members/policy holders containing optional dividend and agent information, automatically emailing said letters to the intended recipient as well as to generate reports and check data for member dividends and agent rewards;
means for define security to users such as managers, agents and members/policy holders allowing them to access pertinent information online from anywhere with an internet connection, functionally attached to said means for a software application, residing either online or on the client's server or pc; and
means for is the output data available to said insurance entity providing dividend information in detail, in summary and all information needed to generate checks or credit entries into another system. also data for optional agent reward checks.

2. The return of excess contribution system (“recs”) dividend distribution software application in accordance with claim 1, wherein said means for a software application, residing either online or on the client's server or pc comprises an overall view of this software application referred to as “recs”.

3. The return of excess contribution system (“recs”) dividend distribution software application in accordance with claim 1, wherein said means for access to data from said insurance entitie's said existing insurance administration system(s). this data access is either linked to or imported into said software application comprises a data access.

4. The return of excess contribution system (“recs”) dividend distribution software application in accordance with claim 1, wherein said means for using said software application, describing their company to the application including name, address, logo and signature file and to assign terminology used in reports and screens to match their corporate culture. then the means to model multiple dividend distribution ‘scenarios’, generate the potential outcome of each scenario allowing company to compare them side by side for the purpose of choosing the one that best meets their dividend distribution needs comprises a modeling tool.

5. The return of excess contribution system (“recs”) dividend distribution software application in accordance with claim 1, wherein said means for administering the chosen dividend scenario, specifically to generate distribution reports, generate user defined form letters for agents and members/policy holders containing optional dividend and agent information, automatically emailing said letters to the intended recipient as well as to generate reports and check data for member dividends and agent rewards comprises a dividend administration tools.

6. The return of excess contribution system (“recs”) dividend distribution software application in accordance with claim 1, wherein said means for define security to users such as managers, agents and members/policy holders allowing them to access pertinent information online from anywhere with an internet connection comprises an online access.

7. The return of excess contribution system (“recs”) dividend distribution software application in accordance with claim 1, wherein said means for is the output data available to said insurance entity providing dividend information in detail, in summary and all information needed to generate checks or credit entries into another system. also data for optional agent reward checks comprises a dividend results data.

8. A return of excess contribution system (“recs”) dividend distribution software application for the purpose of faciliting the administration and distribution of excess insurance premium contributions to a group of members, individuals or entities who pool the premiums of their members, comprising:
an overall view of this software application referred to as “recs”, for a software application, residing either online or on the client's server or pc;
an insurance entity, for insurance entity who pools the premiums of its members and intends to return a portion of the excess contribution back to those members;
an existing insurance administration system, for holds premium, loss, accounts receivable, policy holder and agent data for said insurance entity;
a data access, for access to data from said insurance entitie's said existing insurance administration system(s). this data access is either linked to or imported into said software application;
a modeling tool, for using said software application, describing their company to the application including name, address, logo and signature file and to assign terminology used in reports and screens to match their corporate culture. then the means to model multiple dividend distribution ‘scenarios’, generate the potential outcome of each scenario allowing company to compare them side by side for the purpose of choosing the one that best meets their dividend distribution needs;
a dividend administration tools, for administering the chosen dividend scenario, specifically to generate distribution reports, generate user defined form letters for agents and members/policy holders containing optional dividend and agent information, automatically emailing said letters to the intended recipient as well as to generate reports and check data for member dividends and agent rewards;
an online access, for define security to users such as managers, agents and members/policy holders allowing them to access pertinent information online from anywhere with an internet connection, functionally attached to said Overall View of this software application referred to as “RECS”; and
a dividend results data, for is the output data available to said insurance entity providing dividend information in detail, in summary and all information needed to generate checks or credit entries into another system. also data for optional agent reward checks.

9. A return of excess contribution system (“recs”) dividend distribution software application for the purpose of faciliting the administration and distribution of excess insurance premium contributions to a group of members, individuals or entities who pool the premiums of their members, comprising:
an overall view of this software application referred to as “recs”, for a software application, residing either online or on the client's server or pc;
an insurance entity, for insurance entity who pools the premiums of its members and intends to return a portion of the excess contribution back to those members;
an existing insurance administration system, for holds premium, loss, accounts receivable, policy holder and agent data for said insurance entity;
a data access, for access to data from said insurance entitie's said existing insurance administration system(s). this data access is either linked to or imported into said software application;
a modeling tool, for using said software application, describing their company to the application including name, address, logo and signature file and to assign terminology used in reports and screens to match their corporate culture. then the means to model multiple dividend distribution ‘scenarios’, generate the potential outcome of each scenario allowing company to compare them side by side for the purpose of choosing the one that best meets their dividend distribution needs;
a dividend administration tools, for administering the chosen dividend scenario, specifically to generate distribution reports, generate user defined form letters for agents and members/policy holders containing optional dividend and agent information, automatically emailing said letters to the intended recipient as well as to generate reports and check data for member dividends and agent rewards;
an online access, for define security to users such as managers, agents and members/policy holders allowing them to access pertinent information online from anywhere with an internet connection, functionally attached to said Overall View of this software application referred to as “RECS”; and
a dividend results data, for is the output data available to said insurance entity providing dividend information in detail, in summary and all information needed to generate checks or credit entries into another system. also data for optional agent reward checks.
